(19) United States
(12) Patent Application Publication
(10) Pub. No.: US 2004/0029617 A1
(43) Pub. Date: Feb. 12, 2004

(54) Track system for telecommunications transmission stations

(75) Inventor: Michael Patrick Flynn, Cota de Caza, CA (US)

Correspondence Address: ORRICK, HERRINGTON & SUTCLIFFE, LLP, 4 PARK PLAZA, SUITE 1600, IRVINE, CA, 92614-2558, US

(73) Assignee: MPF Technologies, Inc.

(21) Appl. No.: 10/355,992

(22) Filed: Jan. 31, 2003

Related U.S. Application Data
(60) Provisional application No. 60/402,486, filed on Aug. 8, 2002.

(51) Int. Cl. H04B 1/38; H04M 1/00

(52) U.S. Cl. 455/561; 455/90.3; 455/575.1

(57) ABSTRACT

A track system and methods of use that facilitate the optimization of the leased area space for antenna and transceiver installation sites. The track system advantageously minimizes lease area space requirements while maximizing transmission capacity of transceiver installations by enabling the installation of more transceiver units or cabinets in the same amount of space previously required for fewer traditional transceiver cabinets. As a result, installation footprints can be custom designed to meet difficult space constraints and additional transceiver cabinets may be installed on existing installation footprints without increasing the leased area's space requirement and renegotiating the lease.

### CROSS REFERENCE TO RELATED APPLICATION

This application is related to application Ser. No. 60/402,486, filed Aug. 8, 2002, which is incorporated herein by reference.

### FIELD OF THE INVENTION

The present invention relates generally to transmission station installations for wireless telecommunications networks and, more particular, to track systems and methods of use that facilitate the optimization of transmission station site space.

### BACKGROUND OF THE INVENTION

Public demand for wireless telecommunications has grown at a tremendous rate. An increasing number of people rely on their wireless phones for an increasing number of uses including voice, messaging, data, video, and internet access. This enormous public demand has in turn fueled the need for additional carrier antenna sites to provide expanded wireless coverage to communities. As the need for additional antenna sites has grown, so too has the need for transmission capacity.

Cell phone carriers typically place their transceiver and other electronic and environmental control equipment in a self-contained cabinet, commonly referred to as a base transceiver station (“BTS”), on property, such as building roof tops, parking lots, and the like, that is leased from private owners and/or municipalities. The lease is typically for a specific amount of space or square footage to accommodate the footprint necessary for the installation of one or more BTS cabinets and clearance for maintenance or repair of the electronic equipment housed in a BTS cabinet. Typical BTS units are quite large and require a clearance of generally about three or four feet to allow the technician to open the cabinet doors and access the equipment within the BTS unit.

Because of the need for clearance for repair or maintenance, the addition of more BTS units to an installation to support an increase in transmission capacity typically requires an increase in installation space or foot print beyond the associated lease area. This can be problematic and inconvenient for the carrier who, as a result of the increased installation footprint, must renegotiate the lease for the installation and reapply for permits for the installation.

Further, as lease space becomes less available, more costly and fraught with stricter planning restrictions, the need to increase the transmission capacity of typical transmission stations becomes more problematic for the carriers. Larger installation footprints tend to be cost prohibitive, while taller installations tend to often be prohibitive by zoning laws.

Thus, it would be desirable to optimize the transmission capacity of a transmission station installation or to be able to increase the transmission capacity of a transmission station installation without increasing the installation space requirements or associated lease space.

### SUMMARY OF THE INVENTION

The present invention is directed to methods and apparatus that facilitate the optimization of the leased area space for an antenna and transmission or transceiver station installation site. In one innovative aspect of the present invention, a track system is provided that advantageously minimizes lease area space requirements for transceiver station installations with increased transmission capacity and enables the installation of more transceiver units or cabinets, such as base transceiver stations (BTS), radio base stations (RBS) and the like, in the same amount of space previously required for fewer transceiver units or cabinets. As a result, installation footprints can be custom designed to meet difficult space constraints and additional transceiver cabinets and cabinets housing other electronic equipment may be installed on existing installation footprints without increasing the leased area's space requirement and renegotiating the lease.

In a preferred embodiment, the track system preferably comprises one or more sets of parallelly spaced tracks, preferably formed of steel, having a predetermined length and spacing to accommodate a desired cabinet installation configuration. The tracks may be mounted on a base formed of steel or the like, to form an easily installable and configurable modular rack. As such, one or more transceiver units may be moveably mounted on the tracks side-to-side, front-to-front, back-to-back, and/or front-to-back. Preferably, the tracks include a ramp at the ends to enable the transceiver units to be installed on the tracks, a guide track along which a wheel, slide, follower or the like, coupled to the transceiver unit may travel, and an anti-tip track along which an anti-tip arm, follower or the like coupled to the transceiver unit travels.

In operation, an area of property that meets the space requirements for a transceiver station installation is leased from a property owner, the space is optimized by installing a track system of the present invention on the leased area, and one or more of a plurality of transceiver units are moveably mounted on the parallelly spaced tracks of the track system. The transceiver unit or units mounted on the tracks may advantageously be shifted laterally along the tracks to provide sufficient clearance for a technician to access the electronic components housed in the transceiver cabinets. Alternatively, the capacity of an existing installation may be increased by installing additional cabinets without having to increase the lease area. This may be accomplished by optimizing the existing installation space by installing the track system of the present invention and mounting one or more additional and/or existing transceiver units onto the track system. Once installed on the track system, the cabinets may be shifted laterally to allow a technician the required clearance for working on the cabinets.

In an alternative embodiment, a modular containment cabinet and track system may be provided to meet individual transceiver installation site characteristics and requirements, and preferably minimize installation footprint and, thus, associated lease area. The track system preferably enables forward mounted cabinets, such as transceiver units, radio base stations and the like, battery back-up cabinets, air conditioner units and the like, to be shifted laterally, side to side, to provide access cabinets mounted in the rear of the containment cabinet. Further, the containment cabinet may advantageously be expanded by combining two or more modules. Alternatively, one or more cabinets housing radio, battery or AC equipment may be mounted on the doors of the containment cabinet and, as the doors are swung open, rotated out of the containment cabinet and out of interference with the lateral pathway of the remaining cabinets to enable them to be shifted laterally on the tracks of the track system.

In another alternative embodiment, a horizontal transceiver cabinet is provided that advantageously comprises horizontally disposed transceiver and battery back-up units. Use of the horizontal transceiver cabinet enables carriers to comply with strict planning restrictions in regard to visual impacts and still meet transmission capacity needs. Each transceiver and battery back-up unit is preferably suspended on individual track systems comprising rolling track rails received in guide rails, and can be easily pulled out for maintenance access. The horizontal transceiver cabinet, which is also modular, may advantageously be expanded by combining several modules.

Other aspects and features of the present invention will become apparent from consideration of the following description taken in conjunction with the accompanying drawings.

### BRIEF DESCRIPTION OF THE DRAWINGS

FIG. 1 is an oblique view of a base transceiver station (“BTS”) cabinet mounted on the tracks of a track system of the present invention.

FIG. 1A is an oblique view of first and second modular rack components of the present invention.

FIG. 2 is a detail view of the BTS cabinet and the track shown in FIG. 1 and taken along line 2 in FIG. 1.

FIGS. 3A and 3B are plan views of a first embodiment of a transceiver station installation incorporating the track system of the present invention.

FIGS. 4A and 4B are plan views of a second embodiment of a transceiver station installation incorporating the track system of the present invention.

FIG. 5 is a front view of the BTS cabinet and rack system of the present invention.

FIGS. 6A and 6B are detail views of the BTS cabinet and track shown in FIG. 5 and taken along lines 6A and 6B in FIG. 5.

FIG. 7 is a side view of the BTS cabinet and rack system of the present invention.

FIG. 8 is a detail view of the BTS cabinet and track shown in FIG. 7 and taken along line 8 in FIG. 7.

FIG. 9 is an oblique view of a modular containment cabinet and track of the present invention.

FIG. 10 is a top view of the cabinet and track system shown in FIG. 9 with the top panel removed.

FIG. 11 is a front view of the cabinet and track system shown in FIG. 9 with the front doors panel removed.

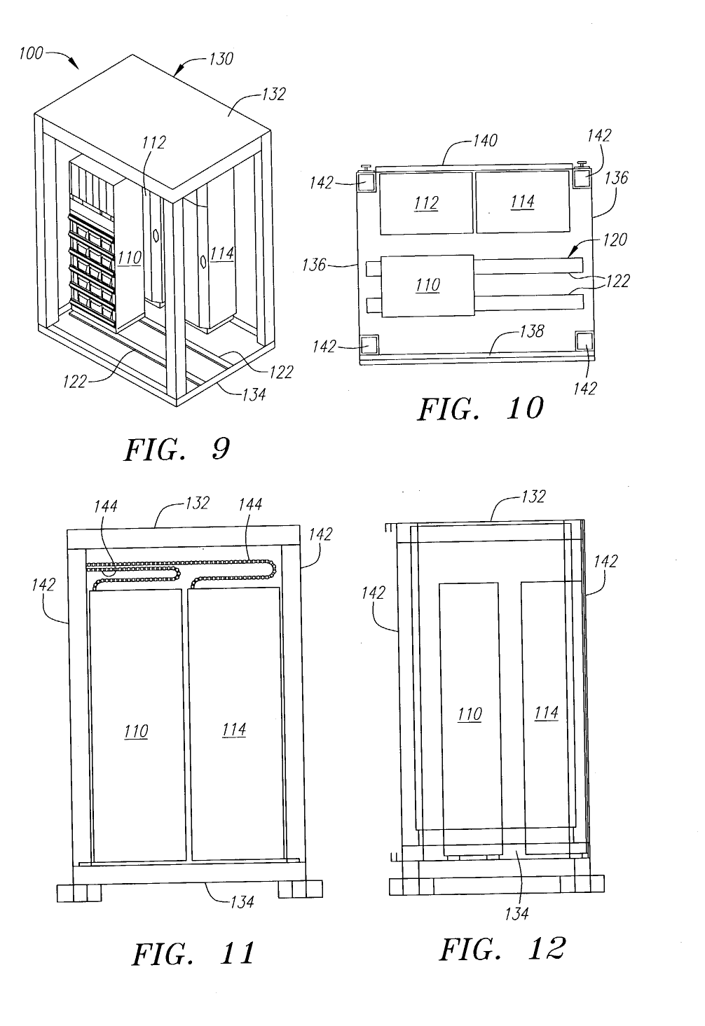

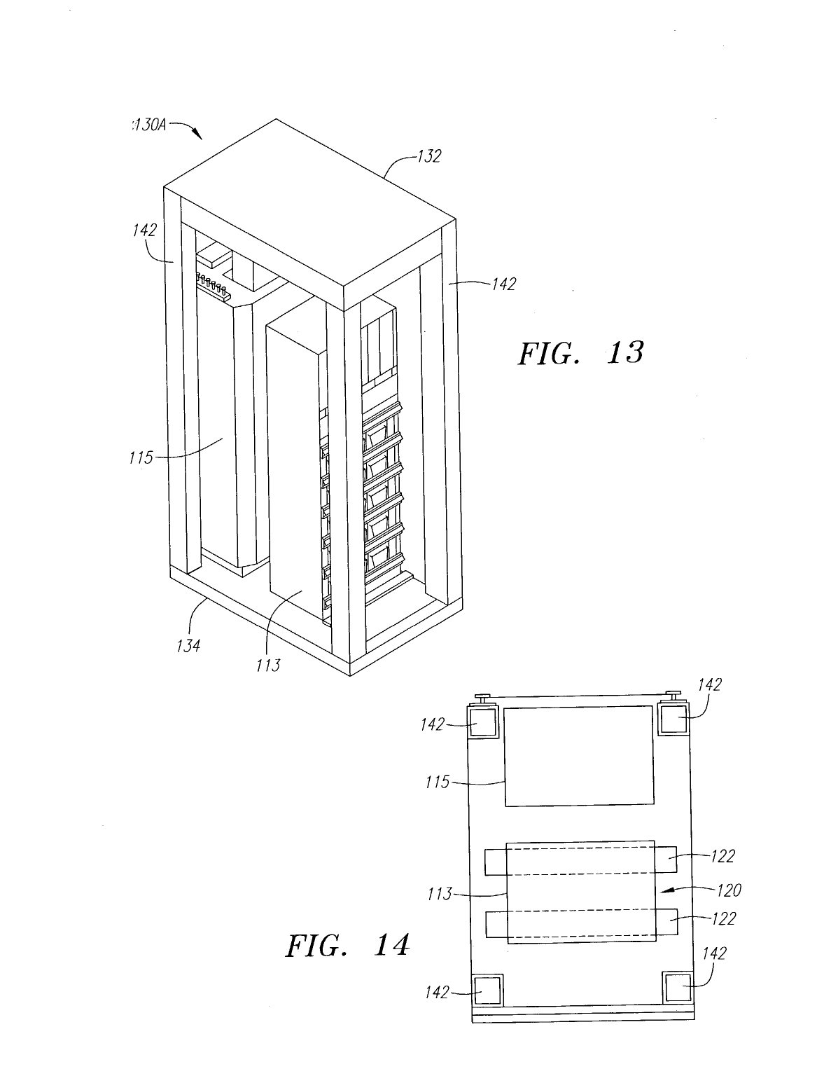

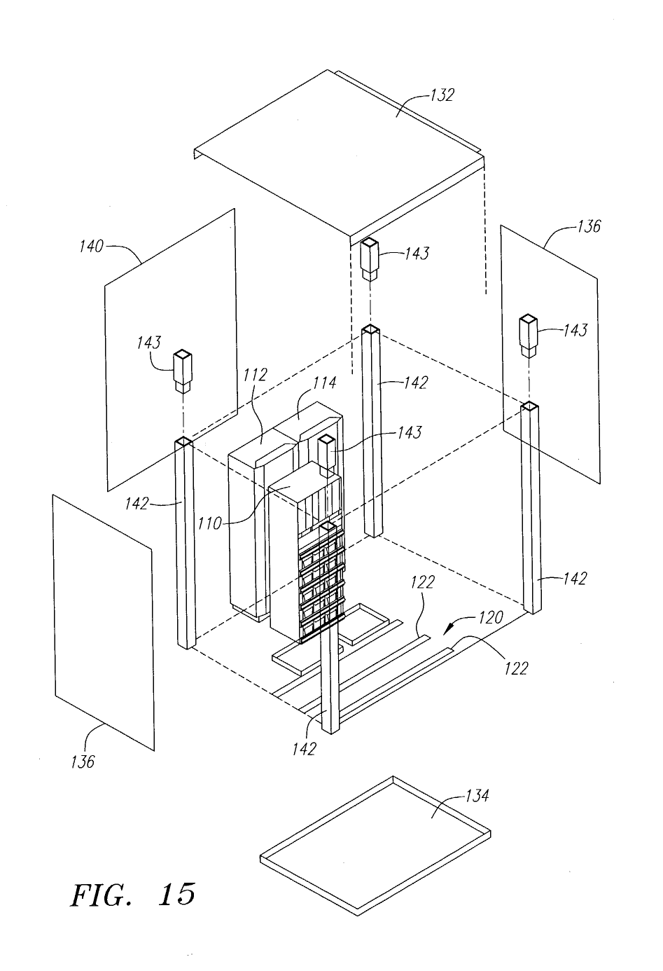

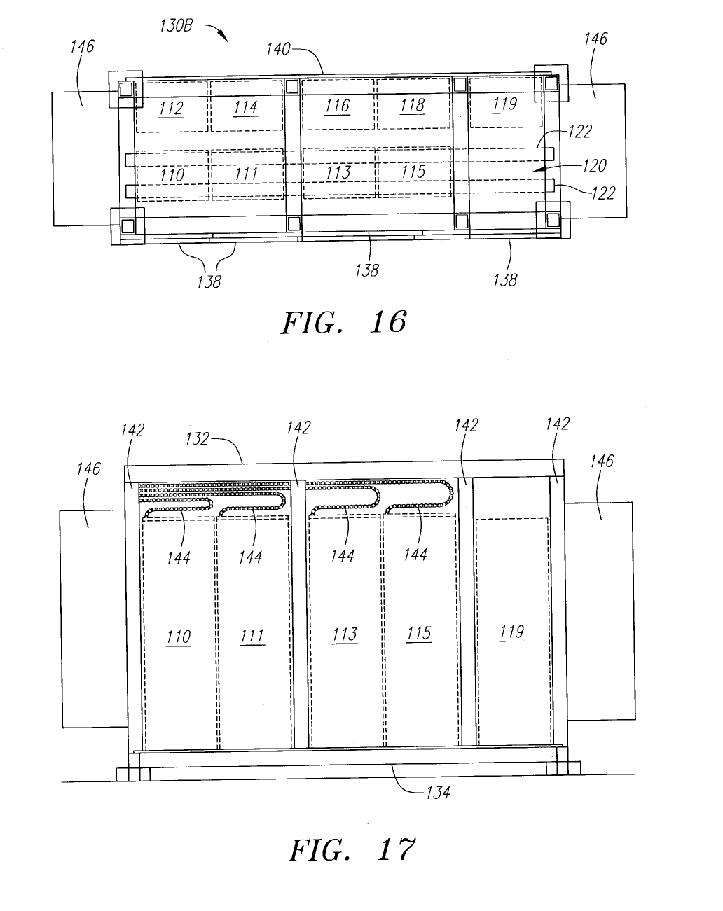

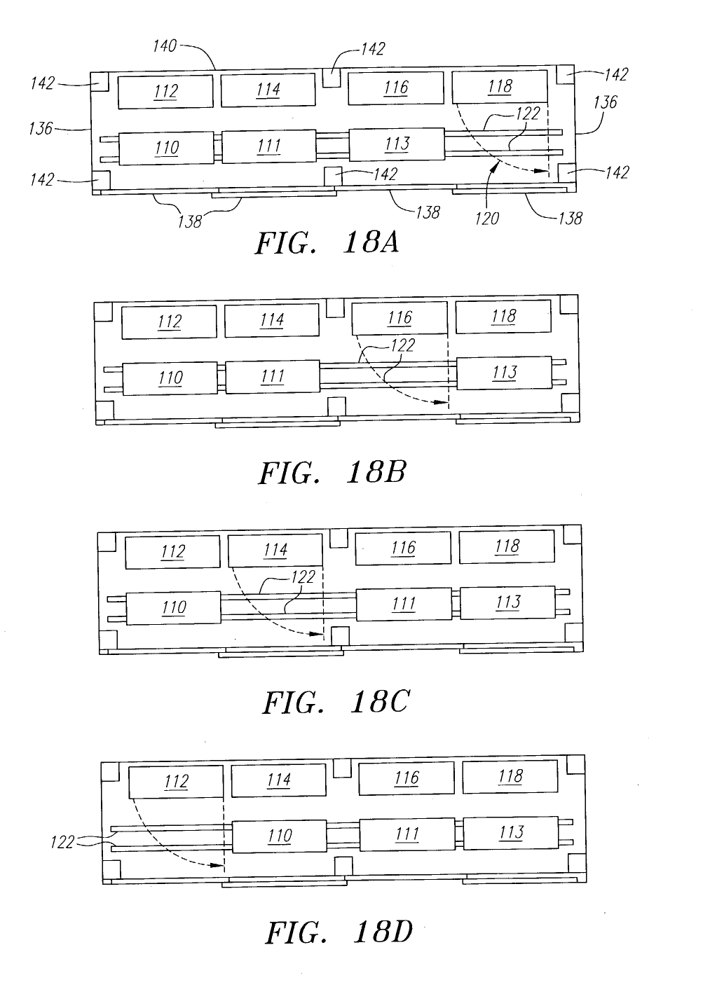

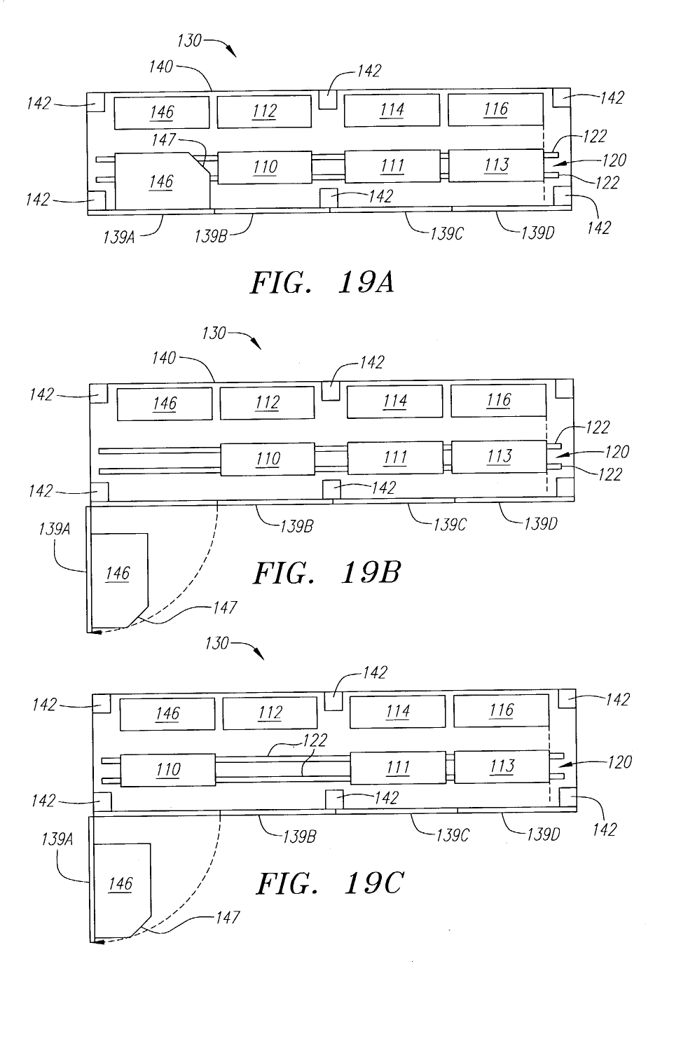

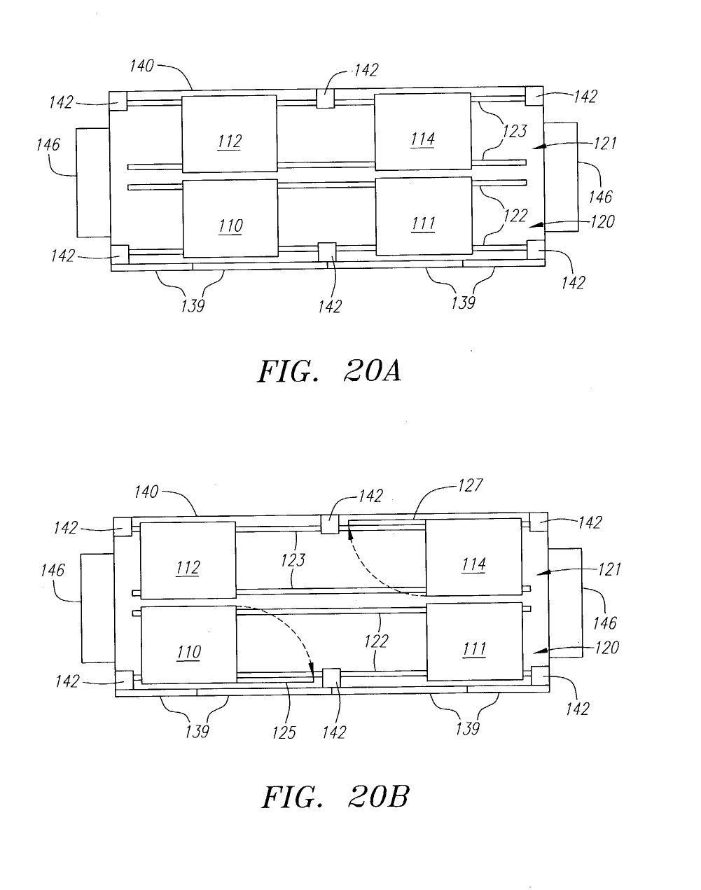

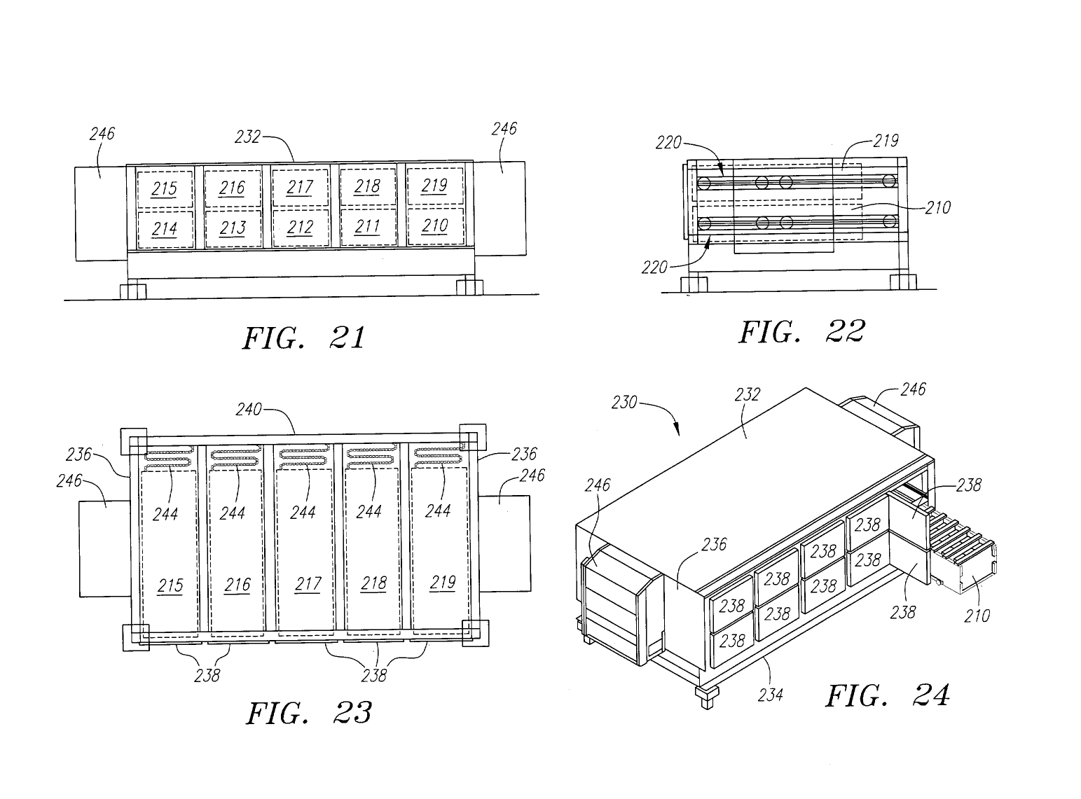

FIG. 10 is a side view of the cabinet and track system shown in FIG. 9 with the side panel removed.

FIG. 13 is an oblique view of an expansion module to the cabinet and track system shown in FIG. 9.

FIG. 14 is a top view of the expansion module shown in FIG. 13 with the top panel removed.

FIG. 15 is an oblique exploded assembly view of the cabinet and track system shown in FIG. 9.

FIG. 16 is a top view of the cabinet and track system of the present invention with connected expansion modules for use with nine transceiver and battery backup units.

FIG. 17 is a front view of the cabinet and track system shown in FIG. 16.

FIGS. 18A-18D are top views showing the operation of the track system in the cabinet and track system embodiment of the present invention.

FIGS. 19A-19C are top views showing an alternate embodiment of the cabinet and track system of the present invention and the operation thereof.

FIGS. 20A-20B are top views showing another alternate embodiment of the cabinet and track system of the present invention and the operation thereof.

FIG. 21 is a front view of a modular containment cabinet housing horizontally disposed transceiver and battery backup units.

FIG. 22 is a side view of the cabinet shown in FIG. 21.

FIG. 23 is an oblique view of the cabinet shown in FIG. 21.

FIG. 24 is a top view of the cabinet shown in FIG. 21.

FIG. 25 is an oblique exploded assembly view of the cabinet shown in FIG. 21.

### DETAILED DESCRIPTION OF PREFERRED EMBODIMENTS

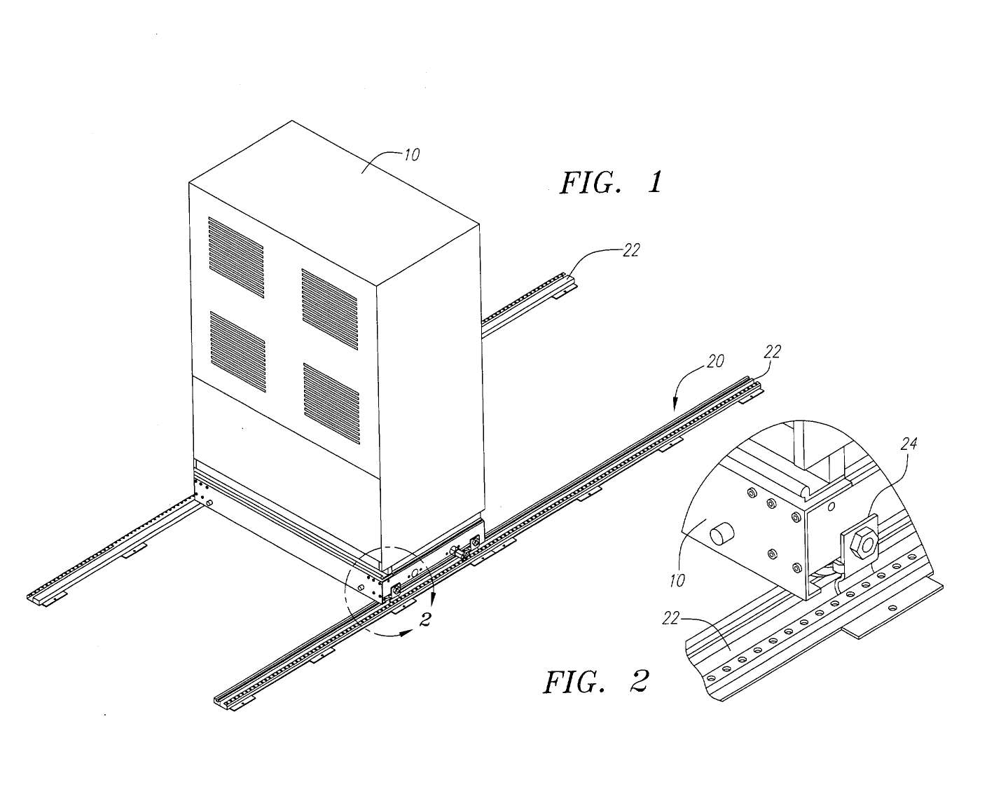

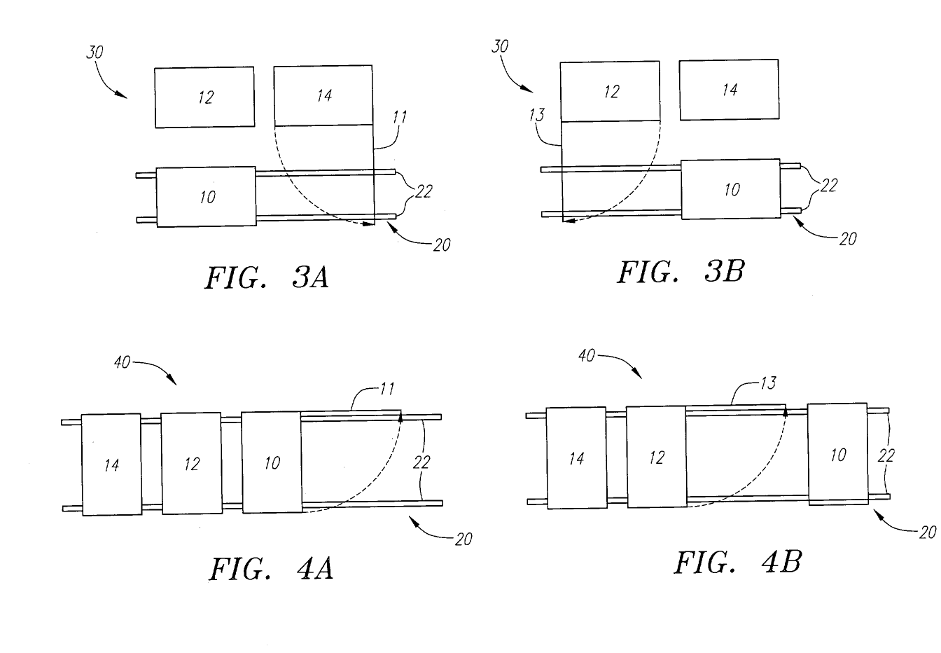

Referring to FIG. 1, a cabinet 10, such as a base transceiver station (BTS), radio base station (RBS), electronic equipment cabinet or the like, is shown mounted on a track system 20 of the present invention. In a preferred embodiment, the track system 20 preferably comprises one or more sets of parallelly spaced tracks 22, preferably formed of steel, having a predetermined length and spacing to accommodate a desired cabinet installation configuration. As shown in FIGS. 3A-B and 4A-B, one or more of a plurality of BTS, transceiver, or other electronic equipment cabinets 10, 12, and 14 may be mounted on the tracks 22 side-to-side, front-to-front, back-to-back, and/or front-to-back, and laterally moveable along the tracks 22.

As shown in FIG. 1A, the tracks 22 may be mounted on a base 21 formed of steel or the like, to form a modular rack 27 and 29. Two or more of the modular racks 27 and 29 may be coupled together using a tongue 23 and groove 25 configuration, or some other means to align and couple the racks, to form a track system 20A of a desired configuration or size. Although shown on the ends of the racks 27 and 29, the aligning and coupling members 23 and 25 may be attacked or formed on the sides of the racks 27 and 29.

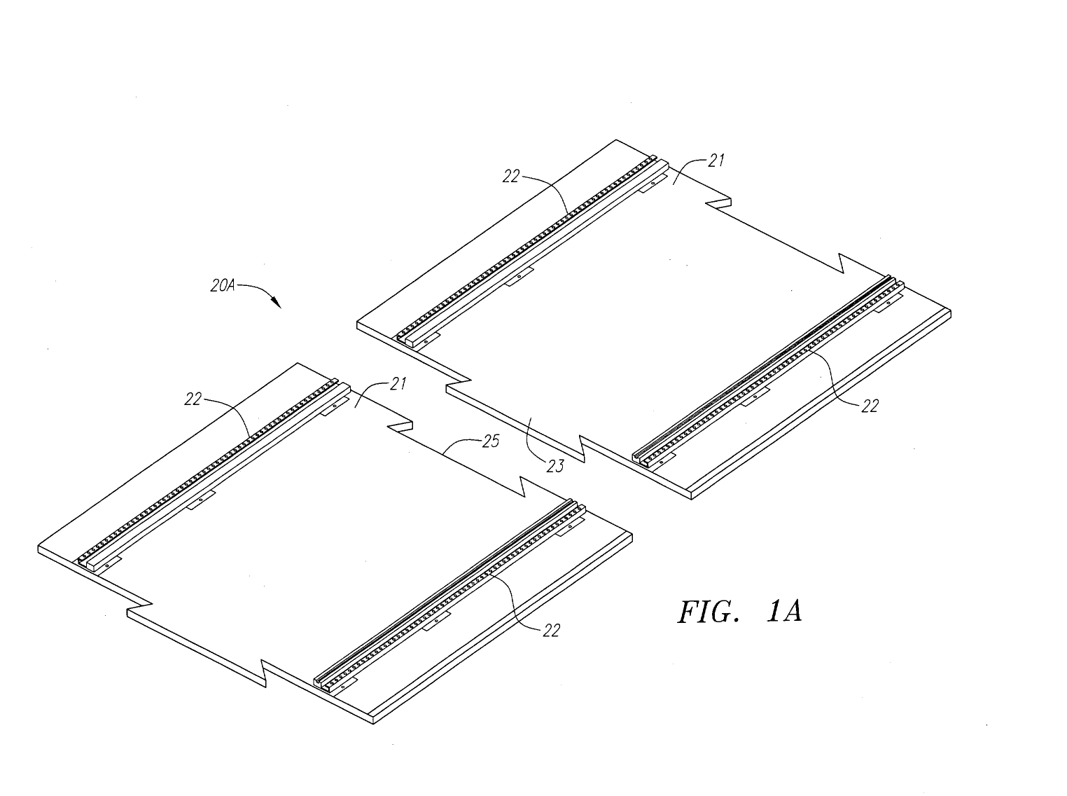

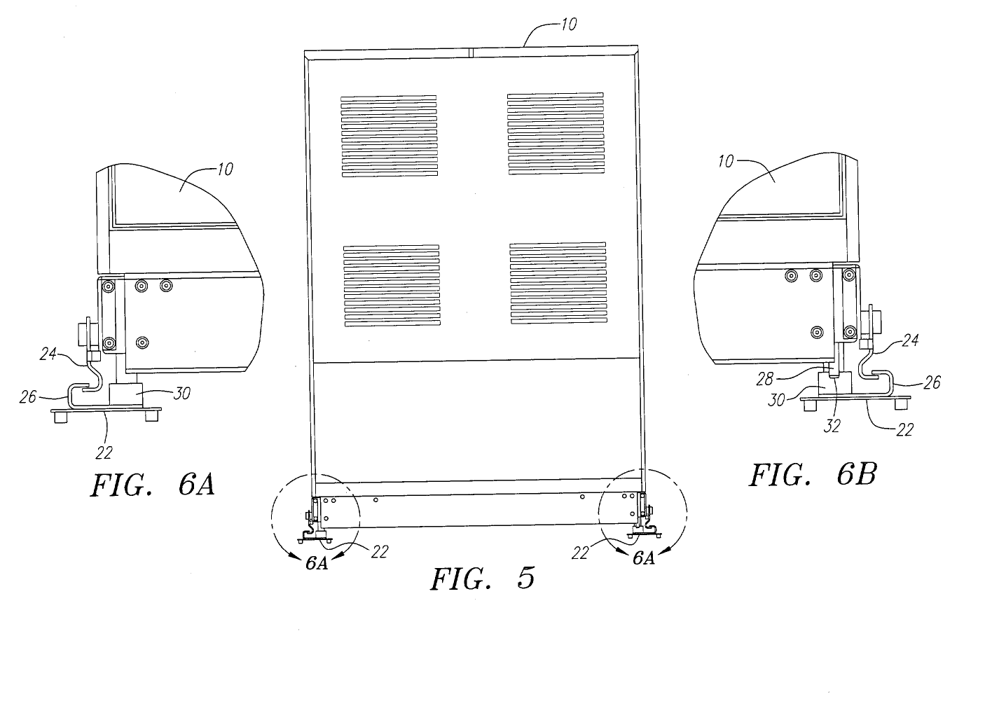

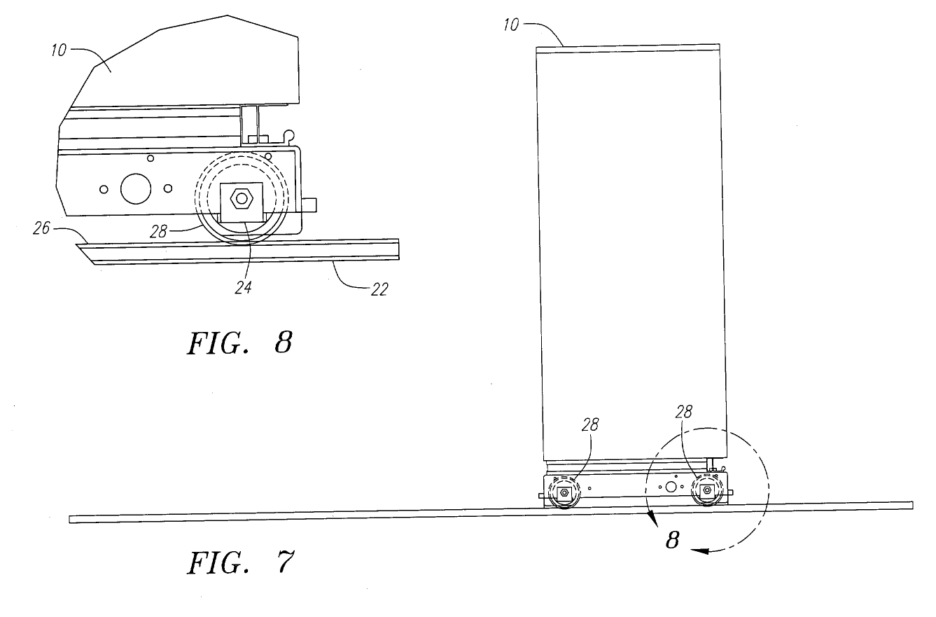

Referring to FIGS. 2 and 5 through 8, the tracks 22 preferably include a ramp (not shown) at their ends to enable a BTS or transceiver cabinet 10 to be installed on the tracks 22, a guide track 30 and an anti-tip track 26. The guide track 30 may be flat or may preferably include a wheel saddle, groove or the like 32, along which wheels 28, feet, slides, followers or the like coupled to the BTS or transceiver cabinet 10 travel. An anti-tip arm 24, follower or the like is preferably coupled to the cabinet 10 and adapted to slidably engage the anti-tip track 26 as the cabinet 10 travels along the tracks 22.

In operation, an area of property that meets the space requirements for a transceiver installation site, comprising one or more BTS or transceiver cabinets, is preferably leased from a property owner. Use of the space or transmission capacity for a transceiver installation on the space is preferably optimized by installing the track system 20 or 20A of the present invention on the leased area. Once the track system 20 or 20A is installed, one or more BTS or transceiver units 10, 12 and 14 may be moveably mounted on the parallelly spaced tracks 22 of the track system 20 as shown in FIGS. 3A-B and 4A-B. The BTS or transceiver units 10, 12 and 14 may advantageously be laterally shifted along the tracks 22 to provide sufficient clearance for a technician to open the cabinet doors 11 and 13 and access the electronic components housed in the BTS or transceiver cabinets 10, 12, and 14. As shown in FIGS. 3A and 3B, a moveable BTS or transceiver cabinet 10 is shifted laterally along the tracks 22 relative to stationary BTS or transceiver cabinets 12 and 14 to allow the technician to open the doors 11 and 13 of the cabinets 14 and 12, respectively. However, as shown in FIGS. 4A and 4B, each of the BTS or transceiver cabinets 10, 12 and 14 may be mounted on the tracks 22 and may be shifted laterally to create sufficient clearance to open the doors of one of the cabinets.

Alternatively, the transmission capacity of an existing installation site may be increased without increasing the associated lease area. Increasing the transmission capacity of the existing installation site may be accomplished by optimizing the existing leased space by installing the track system 20 of the present invention on the leased space and, as shown in FIGS. 3A-B and 4A-B, mounting one or more of additional and/or existing BTS or transceiver units 10, 12 and 14 on the track system 20. Once installed on the track system, the BTS or transceiver cabinets 10, 12 and 14 may be moved laterally to allow a technician the required clearance for working on the cabinets 10, 12 and 14 and the electronics housed therein.

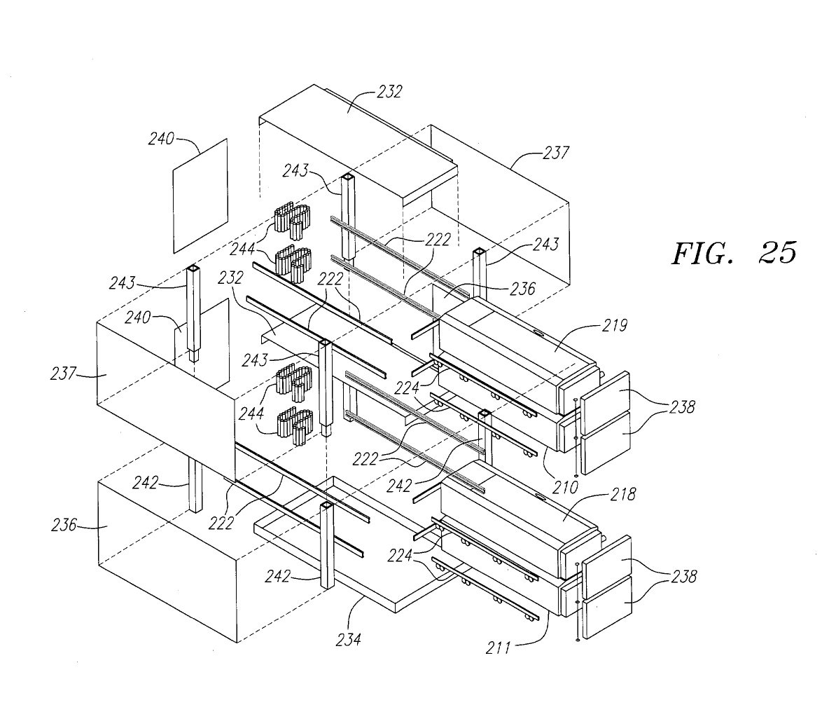

Turning to FIGS. 9 through 18, a modular containment cabinet and track system 130 of the present invention is shown that can be configured to meet installation site characteristics and requirements for individual transmission or transceiver stations. The containment cabinet and track system 130 preferably minimizes the installation footprint of the transmission station and, thus, minimizes the amount of associated lease area. The track system 120 of the containment cabinet 130 preferably enables forward mounted cabinets, which may include transceivers, radio base stations and the like, and battery back-up cabinets 110, 112, 114, etc., or cabinets housing other electronic equipment, air conditioning units, and the like, to be shifted laterally, side to side, to provide access to rear-mounted stationary cabinets 112 and 114.

For the same transmission capacity of traditional exterior self-contained cabinet installations, such as BTS installations, the containment cabinet and track system 130 of the present invention tends to require approximately 50% less lease area and tends to be 50% lighter when filled with transceiver and battery back-up cabinets 110, 112 and 114 resulting in lower lease and engineering costs for a carrier.

The containment cabinet 130 may be formed from a single quad module 130 as shown FIGS. 9 through 12, or by combining two or more bi modules 130A (as shown in FIGS. 13 and 14), quad modules or quad and bi modules. As depicted, the quad module 130, as a stand-alone module, preferably holds three cabinets 110, 112 and 114 for radio base stations (RBS), battery backup stations (BBS), or other equipment, wherein the moveable cabinet 110 may be shifted laterally along the tracks 122 relative to the stationary cabinets 112 and 114. The quad module can be easily reconfigured and mated with a bi module 130A (see FIGS. 13 and 14) to increase its cabinet 110, 112, 113, 114 and 115 capacity to five. An additional quad module can be added to increase cabinet capacity to nine. As depicted in FIGS. 16 and 17, a containment cabinet 130B comprising two quad modules and one bi module preferably holds nine cabinets 110, 111, 112, 113, 114, 115, 116, 118 and 119 wherein the moveable cabinets 110, 111, 113 and 115 may be shifted laterally along the tracks 122 relative to the stationary cabinets 112, 114, 116, 118 and 119.

Each module 130 preferably includes removable side 136 and rear 140 panels, a roof 132, sliding doors 138, a base 134 and a track system 130 mounted on and extending the full width of the base 134. The side and rear panels 136 and 140 preferably comprise lightweight composite panels that preferably slide in grooves formed in frame posts 142. Alternatively, the panels may be formed of steel or other materials capable of maintaining security and environmental protection. The side and rear panels 136 and 140 are preferably secured to the roof 132 with bolts or the like. As depicted in FIG. 15, the height of the module may be easily increased with extension posts 143 to accommodate taller cabinets.

In a preferred embodiment, wheels that roll on horizontal tracks 122 are preferably coupled to the base of the forward-mounted cabinets 110, 111, 113 and 115. This advantageously allows the forward mounted cabinets to be shifted laterally for maintenance access to rear-mounted cabinets 112, 114, 116 and 118. Coaxial data and power cables are preferably routed to the moveable cabinets 110, 111, 113, 115, etc., using flexible cable tracks 140 such as KabelSchlepp's Plastitrak™, Versatrak™, Varitrak™, Profile™, Quantum™ or Conduflex™ hose and cable carrier products. Sliding front door panels 138 allow access while maintaining security and environmental protection. Environmental control systems 146 are depicted as mounted on the sides of the containment cabinet 130, but may be mounted within the containment cabinet. However, where environmental control or air conditioning equipment is internal housed in a moveable cabinet, air flow is preferably routed to the cabinet using flexible ducting.

In operation, the track system of the containment cabinet 130 allows maintenance access to rear mounted cabinets. As depicted in FIGS. 18A through 18D, access to a first rear mounted cabinet 118 is allowed by laterally shifting all moveable cabinets 110, 111 and 113 to the left and opening the door of the first rear mounted cabinet 118. Access to a second rear mounted cabinet 116 is allowed by shifting a first moveable cabinet 113 laterally to the right along the tracks 122 and, if not already shifted, shifting second and third moveable cabinets 111 and 110 to the left. Access to a third rear mounted cabinet 114 is allowed by shifting a second moveable cabinet 111 laterally to the right along the tracks 122 if the first moveable cabinet 113 is already shifted, or by shifting first and second moveable cabinets 113 and 111 to the right and, if not already shifted, shifting a third moveable cabinet 110 to the left. Access to a fourth rear mounted cabinet 112 is allowed by shifting a third moveable cabinet 110 laterally to the right along the tracks 122 if first and second moveable cabinets 113 and 111 are already shifted or by shifting all of the moveable cabinets 110, 111 and 113 to the right.

As an alternative, it may be desirable to further reduce the footprint of the containment cabinet 130 by mounting a cabinet housing RBS or BBS units, or other equipment such as an AC unit on a door of the containment cabinet 130. As depicted in FIGS. 19A, 19B and 19C, an environmental control or AC unit 146A is mounted on a first door 139A of the cabinet 130. A second AC unit is provided in a rear stationary cabinet 1466. With the first door 139A closed, the moveable cabinets 110, 111 and 113 mounted on the tracks 122 of the track system 120 can not, due to the interference by the door mounted cabinet 146A, be shifted laterally to provide access to the rear stationary cabinets 112, 114 and 116. By swinging open the door 139A, the door mounted cabinet 146 is also swung out of the containment cabinet 130 and out of interference with the lateral movement of the track mounted cabinets 110, 111 and 113. To assist in rotating the cabinet 146A out of the containment cabinet 130 or provide sufficient clearance therefore, it may be desirable to provide a cabinet with a chamfered internal corner 147 design. As discussed above, flexible cabling and ducting would be coupled to the cabinet 146A.

In operation, the door 139A with the mounted cabinet 146A is swung open and the mounted cabinet 146A is swung out of the containment cabinet 130 (see FIG. 19B). As such, maintenance access to the rear stationary cabinet 146B adjacent the mounted cabinet 146A is provided. As depicted in FIG. 19C, the first moveable cabinet 110 may be laterally shifted along the tracks 122 to the left to provide access to the adjacent rear stationary cabinet 112 when the second door 139B is opened. Access to the other rear stationary cabinets 114 and 116 can be provided by laterally shifting the other moveable cabinets 111 and 113 to the left along the tracks 122 and opening the other cabinet doors 139C and 139D.

As a further alternative, it may be desirable to provide a containment cabinet having a pair of track systems 120 and 121 to accommodate cabinets 110, 111, 112 and 114 as depicted in FIGS. 20A and 20B. As shown in FIG. 20B, the cabinets 110, 111, 112 and 114 may be shifted to the outside along the tracks 122 and 123 to provide sufficient clearance to open their doors, e.g., doors 125 and 127 of cabinets 110 and 114 respectively, for maintenance access.

Turning to FIGS. 21 through 25, a horizontal transceiver cabinet 230 is shown. The transceiver cabinet 230 includes RBS and BBS cabinets 210, 211, 212, 213, 214, 215, 216, 217, 218 and 219, or cabinets housing other electronic or environment control equipment advantageously horizontally disposed in pairs to minimize height. Use of the horizontal transceiver cabinet of the present invention tends to enable carriers to comply with strict planning restrictions in regard to visual impacts and still meet transmission capacity needs. Like the modular containment cabinet 130 described above, the transceiver cabinet tends to save approximately 50% on lease area and weight in relation to a typical BTS installation having the same transmission capacity. As shown in FIG. 25, the transceiver cabinet 230 is a modular system formed from side and rear panels 236 and 240 slidably received in grooves formed in frame posts 242 and secured to a roof 232. The frame posts 242 are secured to a base 234. Each transceiver module preferably holds two cabinets (RBS or BBS), e.g., upper and lower cabinets 219 and 210, which are preferably suspended on individual track systems 220 comprising rolling track rails 224 received in guide rails 222, and can be easily pulled out for maintenance access after opening its individual door 238. Coaxial data and power cables preferably are routed using flexible cable tracks 244, as discussed above, extending to the back end of each cabinet. If desirable to stack two modules together, the height of the transceiver cabinet 230 can be easily increased by adding extension posts 243 and additional side and rear panels 237 and 240.

Environmental control for the containment cabinet 130 and horizontal transceiver cabinet 230 is accomplished using two air conditioning units running lead lag. As a result, the environmental control system provides a weight, size, maintenance, energy and cost savings over traditional exterior cabinet installations that utilize two air conditioners for each cabinet. Cool air is routed over each cabinet and is drawn through the cabinets by internal cabinet fans. Hot air exhaust from the cabinets is routed back to the AC units through a series of ducts to prevent mixing and promote energy efficiency.

The methods and apparatus of the present invention described above facilitate the optimization of the leased area space for an antenna and transceiver installation site. The slidable rack system 20, 120 and 220 advantageously minimizes lease area space requirements to enable the installation of more transceiver units or cabinets in the same amount of space previously required for fewer BTS-type cabinets. As a result, the installation footprints can be custom designed to meet difficult space constraints. In addition, existing installation may be upgraded by adding transceiver units or other radio cabinets without increasing the associated leased area's space requirements and renegotiating the lease.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A transceiver installation site for a wireless communication network comprising
a track system, and
a plurality of transceiver units wherein at least one of the plurality of transceiver units is moveably mounted on the track system.

2. The installation site of claim 1 wherein the at least one of the plurality of transceiver units mounted on the track system is laterally shiftable to provide access to another one of the plurality of transceiver units.

3. The installation site of claim 1 wherein each of the plurality of transceiver units is moveably mounted on the track system.

4. The installation site of claim 1 wherein the track system comprises one or more pairs of parallely spaced tracks.

5. The installation site of claim 4 wherein each of the tracks comprise a ramp coupled to at least one end of each track.

6. The installation site of claim 4 wherein each of the tracks comprise
a guide track, and
an anti-tip track.

7. The installation site of claim 6 wherein the guide track includes a saddle extending the length of the guide track.

8. The installation site of claim 6 further comprising
a plurality of wheels coupled to the at least one of the plurality of transceiver units mounted on the track system and operably coupled to the guide tracks, and
a plurality of anti-tip arms coupled to the transceiver units and operably coupled to the anti-tip tracks.

9. The installation site of claim 1 further comprising a containment cabinet housing the plurality of transceiver units and the track system.

10. The installation site of claim 9 wherein the at least one of the plurality of transceiver units mounted on the track system is laterally shiftable to provide access to another one of the plurality of transceiver units.

11. The installation site of claim 9 wherein the containment cabinet is formed from a plurality of modules.

12. The installation site of claim 11 wherein the containment cabinet is extendable in width.

13. The installation site of claim 11 wherein the containment cabinet is extendable in height.

14. The installation site of claim 11 wherein the containment cabinet comprises
a plurality of frame posts forming a frame,
a bottom panel coupled to the plurality of frame posts,
a top panel,
side and rear panels coupled to the top panel and frame, and
a plurality of doors operably coupled to the frame.

15. The installation site of claim 9 wherein the transceiver units are horizontally disposed.

16. The installation site of claim 9 further comprising a flexible wire track coupled to the at least one of the plurality of transceiver units mounted on the track system.

17. The installation site of-claim 9 further comprising an environmental control system operably coupled to each of the plurality of transceiver units.

18. A method for minimizing lease area space requirements for wireless communication network transceiver installation sites comprising the steps of
installing a track system on the leased space,
installing a plurality of transceiver units on the leased space, and
moveably mounting at least one of the plurality of transceiver units on the track system.

19. The method of claim 18 further comprising the step of moveably mounting the remainder of the plurality of transceiver units on the track system.

20. The method of claim 19 further comprising the step of laterally shifting one of the plurality of transceiver units to provide access to another of the plurality of transceiver units.

21. The method of claim 18 further comprising the step of laterally shifting the at least one of the plurality of transceiver units mounted on the track system to provide access to another of the plurality of transceiver units.

22. The method of claim 18 further comprising the step of housing the track system and the plurality of transceiver units in a containment cabinet.

23. The method of claim 22 further comprising the step of horizontally disposing the plurality of transceiver units within the containment cabinet.

24. The method of claim 22 further comprising the step of operably coupling all of the plurality of transceiver units to an environmental control system.

25. The method of claim 22 further comprising the step of laterally shifting the at least one of the plurality of transceiver units mounted on the track system to provide access to another of the plurality of transceiver units.

26. A method comprising the steps of
leasing an area of property that meets the space requirements for an installation of a transceiver system, and
increasing the transmission capacity of the installation without increasing the corresponding lease area.

27. The method of claim 26 wherein the increasing transmission capacity step comprises
installing a track system on the lease area, and
moveably mounting at least one of a plurality of transceiver units on tracks of the track system.

28. The method of claim 27 further comprising the step of shifting the at least one of the plurality of transceiver units mounted on the track system along the track system to create sufficient clearance to enable a technician to access another of the plurality of transceiver units.

29. The method of claim 28 further comprising the step of moveably mounting the remainder of the plurality of transceiver units on the track system.

30. The method of claim 29 further comprising the step of laterally shifting one of the plurality of transceiver units to provide access to another of the plurality of transceiver units.

31. The method of claim 27 further comprising the step of housing the track system and the plurality of transceiver units in a containment cabinet.

32. The method of claim 31 further comprising the steps of moveably mounting the remainder of the plurality of transceiver units on the track system and horizontally disposing the plurality of transceiver units within the containment cabinet.

33. The method of claim 27 further comprising the step of operably coupling all of the plurality of transceiver units to an environmental control system.

34. A method of increasing the capacity of an antenna and transceiver installation site without increasing the installation site footprint comprising the steps of
installing a track system on the installation site, and
moveably mounting at least one of a plurality of transceiver units on the track system.

35. The method of claim 34 further comprising the step of moveably mounting the remainder of the plurality of transceiver units on the track system.

36. The method of claim 35 further comprising the step of laterally shifting one of the plurality of transceiver units to provide access to another of the plurality of transceiver units.

37. The method of claim 34 further comprising the step of laterally shifting the at least one of the plurality of transceiver units mounted on the track system to provide access to another of the plurality of transceiver units.

38. A transceiver cabinet comprising
a base,
a frame coupled to the base,
a top,
a plurality of side walls coupled to the top and frame,
a track system coupled to the base, and
a plurality of transceiver and battery back-up units mounted within the cabinet with at least one of the plurality of transceiver and batter back-up units moveably mounted on tracks of the track system.

39. The cabinet of claim 38 wherein the at least one of the plurality of transceiver units mounted on the track system is laterally shiftable to provide access to another one of the plurality of transceiver units.

40. The cabinet of claim 39 wherein the transceiver cabinet is formed from a plurality of modules.

41. The cabinet of claim 40 wherein the transceiver cabinet is extendable in width.

42. The cabinet of claim 40 wherein the transceiver cabinet is extendable in height.

43. The cabinet of claim 40 wherein the frame comprises a plurality of frame posts.

44. The cabinet of claim 40 further comprising a plurality of doors slidably coupled to the frame.

45. The cabinet of claim 40 further comprising a flexible wire track coupled to the at least one of the plurality of transceiver and battery back-up units mounted on the track system.

46. The cabinet of claim 40 further comprising an environmental control system operably coupled to each of the plurality of transceiver and battery back-up units.

47. A transceiver cabinet comprising
a base,
a frame coupled to the base,
a top,
a plurality of side walls coupled to the top and frame,
a track system coupled to the frame,
a plurality of transceiver and battery back-up units horizontally mounted within the cabinet and coupled to the track system.

48. The cabinet of claim 47 wherein each of the plurality of transceiver and battery back-up units are shiftable to provide access thereto.

49. The cabinet of claim 48 wherein the transceiver cabinet is formed from a plurality of modules.

50. The cabinet of claim 49 wherein the transceiver cabinet is extendable in width.

51. The cabinet of claim 49 wherein the transceiver cabinet is extendable in height.

52. The cabinet of claim 47 wherein the frame comprises a plurality of frame posts.

53. The cabinet of claim 47 further comprising a plurality of doors coupled to the frame.

54. The cabinet of claim 47 further comprising a flexible wire track coupled to each of the plurality of transceiver and battery back-up units.

55. The cabinet of claim 47 further comprising an environmental control system operably coupled to each of the plurality of transceiver and battery backup units.

56. A transceiver cabinet comprising
a first module couplable to a second module,
a plurality of cabinets housing electronic equipment and positioned within the first module, and
a track system mounted within the first module, wherein at least one of the plurality of cabinets is movably mounted on the track system.

57. The cabinet of claim 55 further comprising a second module coupled to the first module, wherein the track system extends into the second module and wherein at least another one of the plurality of cabinets is positioned within the second module.

58. The transceiver cabinet of claim 57 wherein the first and second modules comprise
a base,
a frame coupled to the base,
a top, and
a plurality of side walls coupled to the top and the frame, wherein the track systems is coupled to the base.

59. The cabinet of claim 58 wherein the at least one of the plurality of cabinets mounted on the track system is laterally shiftable to provide access to another one of the plurality of cabinets.

60. The cabinet of claim 59 wherein the cabinet is extendable in width.

61. The cabinet of claim 59 wherein the cabinet is extendable in height.

62. The cabinet of claim 59 wherein the frame comprises a plurality of frame posts.

63. The cabinet of claim 59 further comprising a plurality of doors slidably coupled to the frame.

64. The cabinet of claim 59 further comprising a flexible wire track coupled to the at least one of the plurality of cabinets mounted on the track system.

65. The cabinet of claim 59 further comprising an environmental control system operably coupled to each of the plurality of cabinets.
